(19) United States
(12) Patent Application Publication
(10) Pub. No.: US 2025/0220137 A1
(43) Pub. Date: Jul. 3, 2025

(54) VIDEO CONFERENCING TRANSPARENT MONITOR WITH AN INTEGRATED BEHIND-DISPLAY CAMERA

(71) Applicant: Pathway Innovations and Technologies Inc., San Diego, CA (US)

(72) Inventor: Ji SHEN, San Diego, CA (US)

(73) Assignee: Veeo Technology Inc., San Diego, CA (US)

(21) Appl. No.: 18/403,200

(22) Filed: Jan. 3, 2024

(51) Int. Cl. H04N 7/15; G06T 5/10; G06T 5/20; G06T 9/00; G09G 3/3225

(52) U.S. Cl. CPC H04N 7/15; G06T 5/10; G06T 5/20; G06T 9/00; G09G 3/3225

(57) ABSTRACT

A camera device placed behind a display screen with singular resolution and uniform level of transparency, capturing the user on the front side of the display capturing in the camera's FOV at least some of the user's touch gestures when in contact of the display screen. In a preferred embodiment, the display is semi-transparent with at least 25% or more transparency, and the camera is placed at the center of the back surface of the display screen to allow natural looking images of the person's gaze or glance. The camera is integrated with a built-in processor that process application software for viewing captured images from the camera, applies a spatial filter to eliminate certain distortion, embed the camera view image of the person in an mirror image with the digital content being displayed to form a combined new imaging with both person and digital display, and exchanging both video images and on display content with a remote party via a communication server to enable a shared transparent digital “glass board” where both parties can see where the other party is gazing or gesturing or writing over the shared digital content on the “glass board”. Wherein the processor controls the video output and the camera's shutter to synchronize the display's progress scan refresh lines with the camera's rolling shutter scan lines in time and imaging location.

### BACKGROUND OF THE INVENTION

### 1. Field of Invention

The invention relates to a transparent digital display screen with a behind-display camera and techniques for creating video captured through the transparent digital display screen.

### 2. Description of Related Art

Video conferencing has become an essential technology for business. Users seeing each other in an online meeting using webcams help build connection and rapport. Typically, a webcam is located at the top center of a display screen's bezel. This configuration allows individuals to conduct a videoconference where each participant's computer captures a video, which is sent to the other participants. The participants, usually at remote locations, view each other while conversing. A common problem is that the videos give the impression that each participant is looking below the camera because they typically look at what is displayed on the screen, not the camera. This detracts from the experience because of the lack of “eye-to-eye” contact.

To make an online video conference a more natural experience, like a real-life in-person meeting, the webcams need to be located at the center of a screen, not in the bevel above the screen. However, when the camera is placed at the front center of the screen, it blocks the content displayed. Thus, it is highly desirable to position the camera behind the display screen on the back side but at the center, being able to look through the display screen with an unobstructed view. It is essential in this configuration that the digital content displayed on the screen and the screen's internal components do not appear in the camera's field of view (FOV). Such a camera configuration could capture an image of a person in front of the display.

A challenge of using a camera behind the display screen is that conventional display screens are not sufficiently transparent. Unlike a transparent sheet of glass, today's display technologies require millions of pixels physically mounted on a glass substrate where the pixel constructs introduce varying opacity to impede light from getting through adequately. In the case of a thin film transistor (TFT) based liquid crystal display (LCD) screen, which is transparent to a degree, a person in front can see through the screen at objects behind that are well illuminated. However, a camera behind the display can only receive approximately ten percent (10%) of the light from the front. Display pixels with light-emitting diodes (LED) or organic light-emitting diodes (OLED) typically require opaque elements, and today's flat panel displays necessitate a high resolution to achieve the highest level of image clarity. As a result, digital display screen surfaces are densely populated with nontransparent pixels. A display screen that is transparent as clear glass and can display high-resolution content is impractical, if not impossible. Several companies have developed transparent OLED (T.OLED) displays, but finding practical applications has been difficult. LG Display has achieved forty percent (40%) transparency for its T.OLED. It is the world's only manufacturer of large-size T.OLED panels, commercializing a 55-inch high-definition T.OLED display.

Smartphone manufacturers have made numerous attempts to position a camera behind a display screen. For example, U.S. Pat. No. 11,294,422 by Apple discloses a screen divided into regions with different resolutions for each region. Because the objective of the latest and greatest smartphone is to put as many pixels in the display screen as possible to increase the resolution, pixels are sparsely placed at only a particular portion of the display surface where the camera is placed behind to let more light through. In other words, the pixel resolution is significantly decreased at the portion where the camera is located. This may be why all current implementations of a behind-screen camera are placed at the top edge of the screen instead of the center, as having the lowered resolution portion at the screen's center would stand out and degrade the user experience. Another characteristic of a behind-screen camera for mobile phones is that the camera is placed near or in contact with the screen's back surface. This configuration minimizes the number of opaque pixels in the camera's field of view, making correcting the distortion caused by such pixels easier. However, having a dedicated lower-resolution portion of the screen is not desirable. It dramatically complicates manufacturing and increases the cost significantly while not offering more than just aesthetic benefits in industrial design.

U.S. Pat. No. 9,001,184 by Samsung teaches positioning a camera behind a transparent display that alternates the pixel matrix between on and off periods while synchronized with a camera. The camera captures an image when the display is off and does not capture an image when the display is on. The alternating periods are measured by two or three frames. The transparent period of not having an output image on the display is considered as displaying black frames because the pixel matrix emits no light. Yet, the inventors of the present invention have found this technique insufficient. Display screens refresh onscreen and scan in a line-by-line or dot-by-dot manner. As all display screens refresh at a high frequency to minimize response time, especially for displaying high-action content such as video games or movies, as soon as one frame of the screen is completely refreshed, the first scan line of the next frame would need to refresh immediately. In other words, there is no period where a single frame is a black frame entirely or cleanly has no image displayed unless power is shut off to the TFT transistors for every black frame. A complete power shutoff is impractical. For most regular commercially available transparent screens, such as a T.OLED, when a camera attempts to capture an image during a black frame, there will always be remaining lines of pixels that have not been refreshed to black yet.

When creating a behind-the-display camera in conjunction with a transparent display panel, the inventors discovered the most difficult challenge is to overcome the reflection of light emitted from the light-emitting pixels from the nontransparent portion of a pixel. When transmitted through the transparent portions to the back of the display, such reflection is captured by the behind-display camera as a ghost image of the display content. In the ideal use case, a behind-display camera should not “see” any content displayed on the screen and should only see through the screen to capture the person in front. There is also interference when reflected light rays penetrate the adjacent transparent apertures, creating a Moiré pattern. Without treatment, the camera captures the ghost image and the Moiré light interference pattern. Both are undesirable.

Furthermore, with the millions of pixels entirely laid out in an active matrix formation, the opaque portion of the pixels form rows and columns resembling a mesh or a grid. Depending on the specific size and orientation of the pixel placement, grid lines can be thicker or thinner, leading to distortions that are often heavier or stronger along vertical or horizontal directions. A mesh or grid lines distort the image captured from behind the display. It is imperative to eliminate such distortions so that the image appears clear, as if captured with a camera through a sheet of glass.

In yet another aspect, in today's video conferencing systems such as Microsoft Teams, Zoom, and others, the presenting party must use a screen share feature when presenting digital content. At the same time, the camera's view of the person is reduced to a thumbnail on a sidebar or at a corner. The presenter's gaze or gesture is either ignored or is misaligned even when viewed. Such a separated display of the person from the digital content is disorienting for the audience on the remote end. There is a need to embed the presenter's camera view with the on-screen digital content so that the audience can see what the presenter is looking at and where the presenter is pointing, along with the presenter's facial expression and body gestures. Existing video conferencing and online collaborative communications systems are inadequate in addressing such needs.

### SUMMARY OF THE INVENTION

The present invention overcomes these and other deficiencies of the prior art by integrating a transparent display screen, such as a T.OLED monitor, with a behind-display camera positioned along the center axis of the display at a predetermined depth to capture the entire display and its user. The display screen has a uniform resolution and pixel layout. In an embodiment of the invention, the camera comprises a processor that controls the opening and closing of the camera's rolling shutter synchronously with the line-by-line scanning of the display screen's active pixel matrix. The rolling shutter regulates the light reception by the camera's image sensor. The processor and rolling shutter utilize a signal interface such as but not limited to a general purpose input/output (GPIO) connector or an inter-integrated circuit (I2C) connector.

The system is configured in an embodiment to include a USB host input port and an HDMI input port for connecting to an external content source, such as a computer providing one or more video streams. In this embodiment, the system can function, among others, as a second external display for the source computer. The system is configured in another embodiment with an on-the-go (OTG) USB output port and a HDMI output port. In this embodiment, the system can output the display camera's live view stream embedded with digital content on the display in an integrated image stream as a webcam or USB Video Class (UVC) stream to an external host terminal device, such as a host computer.

The invention turns lines of pixels into black color while detecting or controlling a timer to synchronize the black lines' refresh rate on display with the progressive movement of the rolling shutter for the camera sensor. The camera captures a full frame of the person's image on the front side of the transparent display when all the black pixel lines finish scanning, and the synchronized rolling shutter completes all scan lines of the sensor. During this shutter opening period, rolling open scan lines one line by one line, no display content on the display is captured. The camera sees through the display. Such a technique eliminates distortion caused by the previously mentioned Moiré pattern, which results from the cover glass reflecting some of the light emitted by the display image on display and transmitted back through the transparent openings of the display to the sensor. This reflection and Moiré pattern result in a ghost image if the camera's shutter is open when the reflection is visible. While refreshing a line of pixels into a black color, and the scan line of the sensor only sees a line being refreshed into a black line, the camera does not capture any such reflection or Moiré pattern. Therefore, the invention does not capture any ghost images.

Once the camera finishes capturing all lines of pixels to complete a full frame of the person in front of the display, the processor performs spatial filtering to eliminate distortion created by the pattern of nontransparent pixels laid out in columns and rows, often referred to as the mesh on the display and in front of the camera. The inventors have discovered that processing the raw data acquired from the camera in the YCbCr (or any of its variants) color space is advantageous because the brightness information in the Y channel can be isolated for processing. In an embodiment of the invention, the Y-channel is filtered, and the resulting filtered Y channel is recombined with the Cb and Cr channels for an image free of mesh lines. Using the YCbCr color space gains a 3× performance increase because the Y-channel contains brightness information, the primary component of the mesh line introduction. Yet, if processing power is not a consideration, all three channels can be filtered using the techniques disclosed herein.

The digital display content should not be visible to the camera, and the camera should only capture the real-life person and surrounding scene in front of the display. Accordingly, the display content is treated as objects with a transparent background and opaque foreground. At the same time, the person's captured image is digitally reconstructed to be a person embedded within the digital content. The resulting constructed image is the new “camera view” in a preview window, appearing the same as looking at a mirror image of the scene where the person is writing on a glass board where the person's left side is flipped to be the right side and vice versa. Such digital recombination of the display content and person into a single picture allows a viewer of the scene to see where the person is pointing on the display, where and what the person is writing, where and what digital objects like images, shapes, annotation, video, etc., the person is pointing at or gazing at. When such a digitally combined scene is viewed by a remote person as a regular camera view, after transmitting both directions to exchange such person-embedded images, online communication and collaboration are more effective and more engaging. When the current invention is used with an online video conferencing software system like Teams or Zoom, because the digital content is reconstructed with the camera view embedded, there is no need to use screen sharing as the only way to present desktop or window content, in contrast to the prior art where the camera view is reduced into a thumbnail where the presenter's gaze and gesture are disoriented against the content on the screen.

In a further aspect of the invention, when recording a video using the behind-display camera or while conducting a video conference call with remote participants, the person in front of the display may select a particular piece of digital content on the display as the script, which is only visible to that person, similar to the usage scenario of being in front of a teleprompter. The person appears to be looking into the camera naturally without reading the script on the teleprompter. The selected piece of digital content on the display is separated from the digital content so that it is not included in the combined construction of the digital content embedded with the already filtered camera image of the person.

In yet another aspect of the invention, the system can optionally have input ports, such as a host USB port or an input HDMI port, and accept inputs of video streams or human interface device (HID) events from an external content source, such as a computer outputting its desktop images and HID control events. Once connected to the system through the input ports, the display screen is treated as the external content source's second monitor. The software manages the digital construction of local digital content, and the centered behind-display camera in the system, in turn, accepts the input video source as a virtualized camera video stream to enter it into the constructed digital image/scene. If the user selects the external content input stream to be invisible to a recording or a remote video conference call, the external content serves as a script on a digital teleprompter.

In yet another aspect of the invention, the processor of the system is capable of outputting the constructed combined image as a UVC stream, HID event, or HDMI stream through an internal output driver to an external host terminal device and functions as a webcam for the host terminal. To the external terminal device, the system appears just as a webcam. When the host terminal device is a computer, the system is registered and accessible as an ordinary USB camera device, except it shows the behind-display camera view and the fully constructed images with the display digital content and the camera view embedded together.

Another feature of the invention is that a shared digital transparent “glass board” can be formed. The presenter's onscreen digital content is transmitted to a cloud-based server, which distributes the shared content to other participants of a video conference call on their remote computer or mobile device. A software agent executes, often as a background process, on these remote devices to construct virtual camera views by combining the received shared digital content from the cloud server with a left-right flipped local camera view. If a remote participant is using the same system, the remote participant appears to be looking at the same digital content with the person's image being embedded into the scene as well. When the remote participant's system only has a regular webcam at the center of the upper bezel above the display, the person's gaze may appear somewhat misaligned with the digital content. However, the remote participant can still visually align hand gestures to point at the digital content in the constructed image accurately.

When an operating system allows an implementation of the constructed image with the participant's image embedded within the received shared digital content, as a virtual camera driver, video conferencing software may consider such a virtual camera a regular webcam. As a result, the video conferencing software displays each participant's camera view as the digitally constructed image, embedding all participant's images with the shared digital content. The outcome appears as if every participant is positioned alone on the opposite side of a transparent “digital glass board” or “virtual glass board” with the digital content displayed with the correct left-to-right orientation, but the person's image flipped. Every participant can see exactly what and where the other participant is pointing at or writing. When any one of the participants or multiple participants “write” or annotate with the aid of a touch surface, such as an infrared touch surface or projected capacitive touch surface, or simply with a mouse, trackpad, or keyboard, the agent software running on the remote devices transmits the new content acquired on the device to the cloud server to be redistributed to display on every other participant's shared “digital glass board.” This allows every participant to write or paint on every other participant's “digital glass board” display. In case a video conference software vendor makes an application programming interface (API), such as Zoom's API platform, available to third parties, the software agent on each of the remote devices can be programmed into the video conference system as an extension or plug-in instead of a virtual device driver, which is a preferred embodiment for the software agent enabling the shared “digital glass board.”

The foregoing and other features and advantages of the invention will be apparent from the following more detailed description of the invention's preferred embodiments, as shown in the accompanying drawings and the claims.

### BRIEF DESCRIPTION OF THE DRAWINGS

For a complete understanding of the present invention and its advantages, reference is now made to the ensuing descriptions taken in connection with the accompanying drawings briefly described as follows:

FIG. 1 illustrates a prior art system that uses alternating opaque and transparent display phases to synchronize with a camera's global shutter's opening and closing.

FIG. 2 illustrates a progressive line-by-line refreshing cycle of a display.

FIG. 3 illustrates a typical construct of a T.OLED pixel and the layout of opaque and transparent pixel sections.

FIG. 4 illustrates a microscopic view of the layout of pixels in a T.OLED display screen and the formation of a mesh pattern that distorts camera views.

FIG. 5 illustrates how the display's cover glass reflects the light emitted by the T-OLED pixels and creates a Moiré patterned interference and ghost image.

FIG. 5A is an unprocessed photo captured by a behind-display camera where the ghost image interferes with the camera image of the person in front.

FIG. 6 illustrates when a line of pixels' color is turned black, and there is no ghost image or Moiré pattern interference.

FIG. 6A is an image a behind-display camera captures when Moiré pattern interference is removed.

FIG. 7 illustrates how the present invention synchronizes the progressive movement of a rolling shutter of a camera sensor with the progressive line-by-line refresh of the display in front of it.

FIG. 7A is an image a behind-display camera captures when Moiré pattern interference is removed.

FIG. 8A illustrates the present invention.

FIG. 8B illustrates the system of the present invention with input and output ports.

FIG. 9 illustrates the method of the Moiré pattern interference according to an embodiment of the invention.

FIG. 10 illustrates the method of removal of the distortion from a mesh pattern using spatial filtering.

FIG. 11 illustrates the details of the spatial filtering method of the present invention.

FIG. 12 illustrates the frequency domain pattern distribution of mesh interference after performing an FFT.

FIG. 13 illustrates formulating a bandpass filter in the frequency domain to remove a vertical mesh pattern interference according to an embodiment of the invention.

FIG. 14 illustrates formulating a bandpass filter to remove a slanted mesh pattern interference in the frequency domain.

FIG. 15 illustrates creating a correction image and the application of the correction image.

FIG. 15B is a processed photo after removing the Moiré and mesh pattern interference.

FIG. 16 illustrates constructing a person and digital content embedded view image.

FIG. 17 illustrates the effect of disposing the behind-display camera at varying distances from the back of the display.

FIG. 18 illustrates creating a digital teleprompter with the system of the present invention.

FIG. 19 illustrates enabling the system of the present invention as a second monitor of an external content source device like a computer.

FIG. 20 illustrates the method of enabling the system of the current invention to connect to a host terminal device as a webcam.

FIG. 21 illustrates the video conferencing and collaborative communications system using a virtual glass-like shared glass board.

FIG. 22 illustrates the method using the system of the present invention for video conferencing and collaborative communications using a virtual glass-like shared glass board.

### DETAILED DESCRIPTION OF PREFERRED EMBODIMENTS

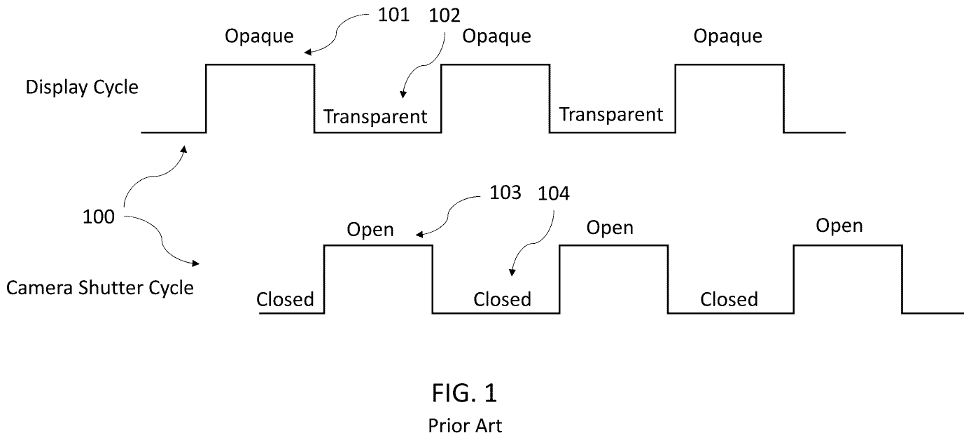

Preferred embodiments of the present invention and their advantages may be understood by referring to FIGS. 1-22. The described features, structures, or characteristics of the invention may be combined in any suitable manner in one or more embodiments. It will be apparent to those skilled in the art that various modifications can be made to the present invention without departing from its spirit and scope. Thus, the current invention is intended to cover modifications and variations consistent with the scope of the appended claims and their equivalents.

While the present invention is discussed in the context of capturing video of a person positioned in front of a transparent display, the present invention can be utilized without a person in front of the transparent display. As used herein, the scope of the term “transparent” includes semi-transparent. For example, the transparency of transparent OLED or T.OLED displays is forty percent (40%), but is considered transparent. Accordingly, any present or future display portrayed as transparent is sufficiently transparent for use in the present invention, regardless of its actual degree of transparency. For this invention, a display with a transparency of fifteen percent (15%) or more is considered transparent.

FIG. 1 illustrates a prior art technique for capturing video through a transparent display. In this technique, the display operates through cycles of opaque frames 101 when the active matrix of LEDs is on and transparent frames 102 when the active matrix is off, and the camera shutter goes through synchronized cycles of open shutter frames 103 and closed shutter frames 104. This makes it purportedly possible for the camera only to capture images when the display is in its transparent display mode. As it may seem reasonable in theory, that is not how displays work in practice. The inventors can not find any commercially available displays that operate in such a manner.

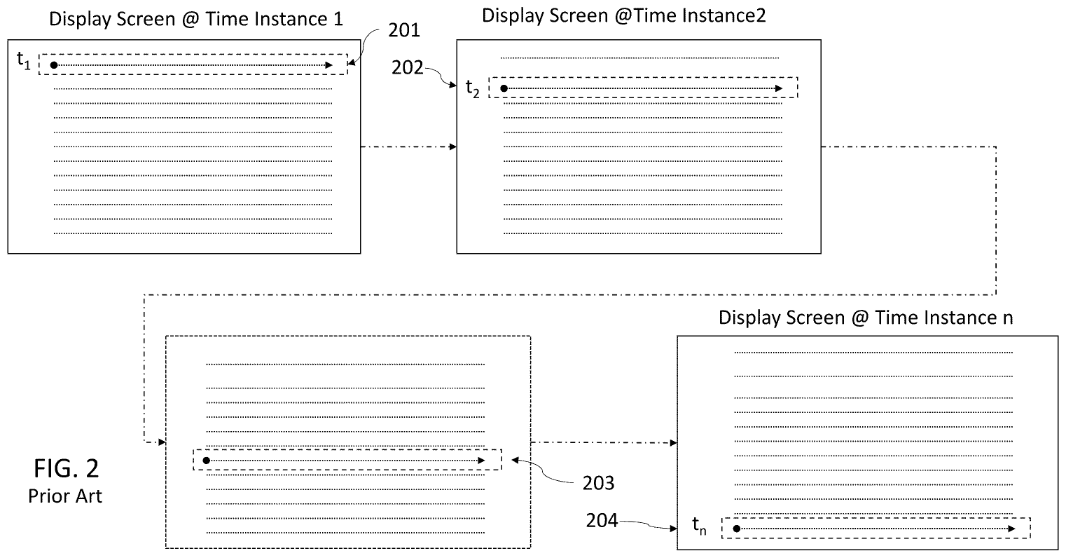

FIG. 2 illustrates that displays like T.OLED progressively refresh each line of pixels on the display. For example, at time instance, t₁, the first line of pixels 201 is refreshed with a new set of colors for the new frame of the image to be displayed. At time instance, t₂, the second line of pixels 202 is refreshed with a new set of colors for the new frame of the image to be displayed. This refresh process repeats line by line until the last line of pixels 204 at time instance tₙ is refreshed, where n is the total number of vertical scan lines in a frame based on the display's resolution specification. For a 720P resolution display, n=720. In slow motion, the refresh process progressing from the top to bottom lines of pixels appears similar to the scan lines of an old cathode ray tube (CRT) TV monitor with lines of phosphorescent pixels glowing by an electron beam to display various color and brightness values at a pixel, then one line of pixels, then all the pixel lines progressively. This means that if one were to use a camera sensor with a global shutter, there is never a time when the whole display screen is turned black, with the exception during the instance between two frames, e.g., 11 μs or 11 microseconds, calculated for a display with 120 Hz refresh rate and 720P resolution as 1 second/120 Hz/720 scan lines≈11.5 μs. However, capturing images at a shutter speed faster than several milliseconds is impractical. 11.5 μs is not enough time for a sensor with a global shutter to capture a frame of image. The prior art teachings are inconsistent with the current state of the art for commercial display products. Short of utilizing a custom-made display that can turn off all pixels at once for multiple milliseconds, it is practical to use the progressive fashion of pixel line refresh on T.OLED displays.

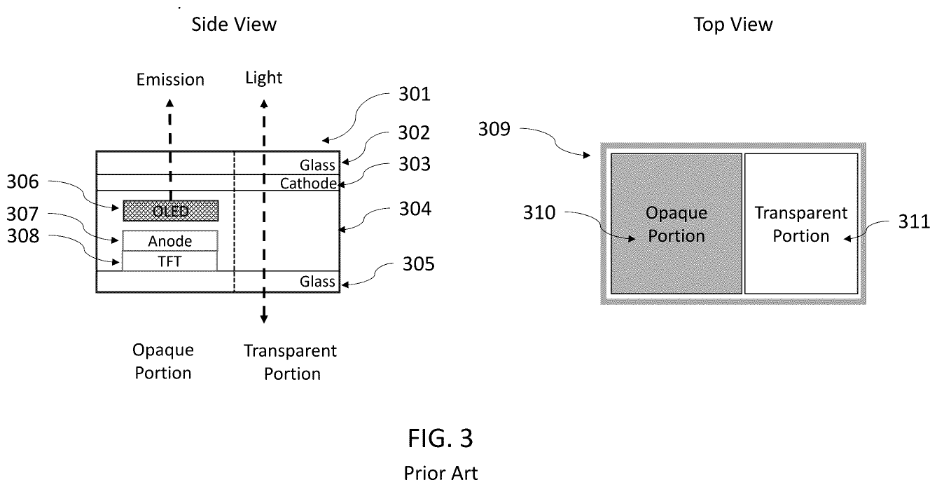

FIG. 3 illustrates a single pixel of a T.OLED display in a top-down view. The whole pixel 301 in the side view comprises two sections, a transparent section 311 and an opaque section 310. The components of the inner workings of a T.OLED display are readily understood by one of ordinary skill in the art and, therefore, not described. To understand the present invention, one of ordinary skill in the art recognizes the pixel stack of OLED 306, anode 307, and TFT 308, which produce the light for the display, also block light from going through the display and are, therefore, considered an opaque optical path. Yet, in the transparent section 311, glass 302, cathode 303, gap 304, and glass 305 are all transparent materials. A T.OLED display is considered transparent because of the transparent section 311 at each pixel. The opaque section 310 remains opaque regardless of the color emitted from the OLED component 306. Even when all the power is cut to the pixel and no light emits from OLED 306, the opaque section 310 remains opaque. A T.OLED display is, therefore, always considered transparent because a portion of each pixel remains transparent.

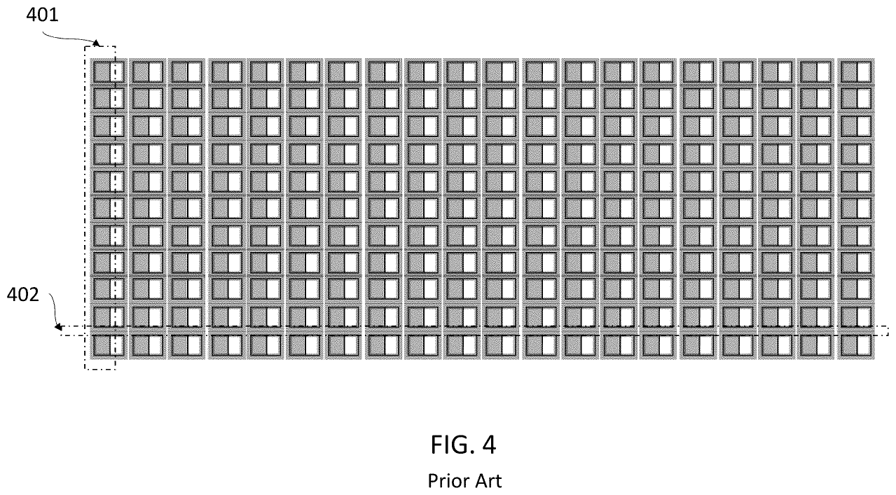

FIG. 4 illustrates the pixel layout in a T.OLED transparent display. In this active matrix formation, the nontransparent opaque section of each pixel is shown in 310 of FIG. 3 and collectively create a layer of a mesh-like structure obstructing and distorting light transmission from the front to the back for the camera disposed behind the display. In particular, for an LG-manufactured T.OLED display, column 401 appears as a heavier vertical pattern and causes more distortion for light than row 402 of gaps between pixels. Such patterns of mesh influence what type of distortion correction technique is required. It is conceivable that a manufacturer can lay out pixels differently than shown, changing distortion patterns caused by the mesh structure.

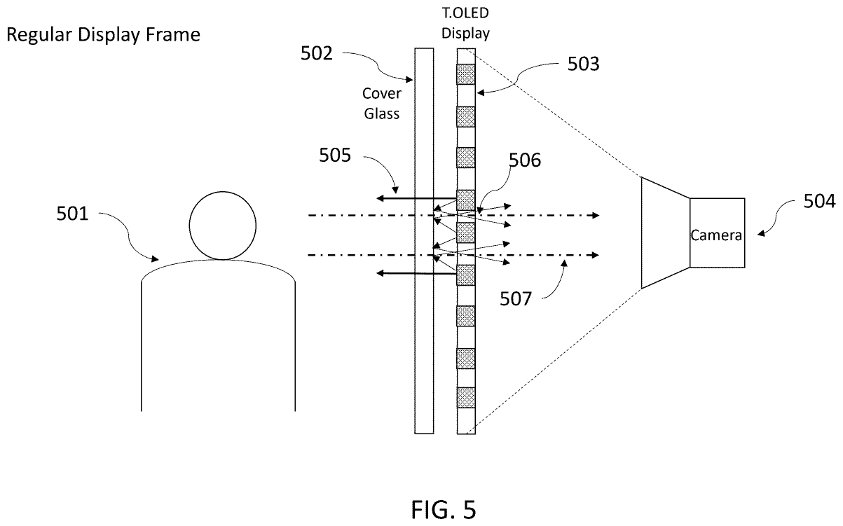

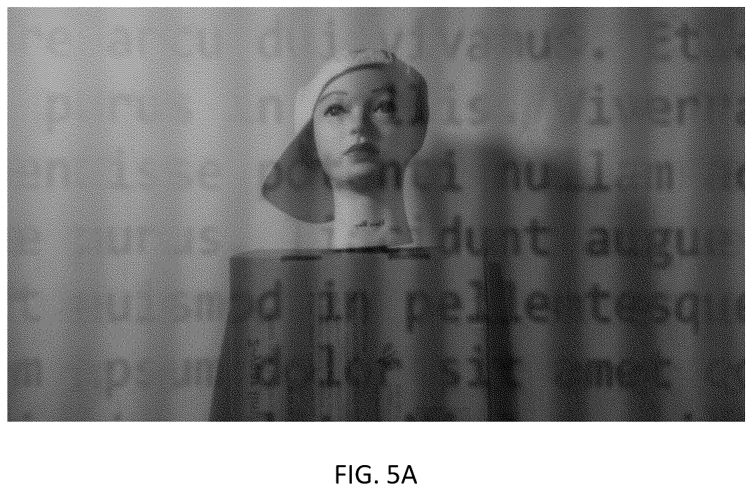

FIG. 5 illustrates how the cover glass for a T.OLED display creates optical interference. The T.OLED display layer 503 has a certain number of pixels depending on its resolution. To protect the T.OLED pixels, a protective cover glass 502 is included. When a pixel emits light 505 transmitting from the pixel to the person 501 in front of the display, the cover glass 502 reflects some of the light 505 backward as light 506 to the camera 504 behind the display through the transparent apertures 311. When these light waves 506 reach the camera's sensor plane, the interaction between these light waves creates a ripple, forming a Moiré pattern. The reflected light waves 506 also create a distorted ghost image captured by the camera 504. The Moiré pattern and distorted ghost image are the most critical distortions to remove. FIG. 5A is a picture of a manikin in front of a T.OLED display captured by a camera behind the display's backside without removing the interference from the reflected and distorted optical pattern or Moiré pattern. As shown in the picture, the ghost image of the digital content (in this instance, text) displayed on the front side of the T.OLED display is present.

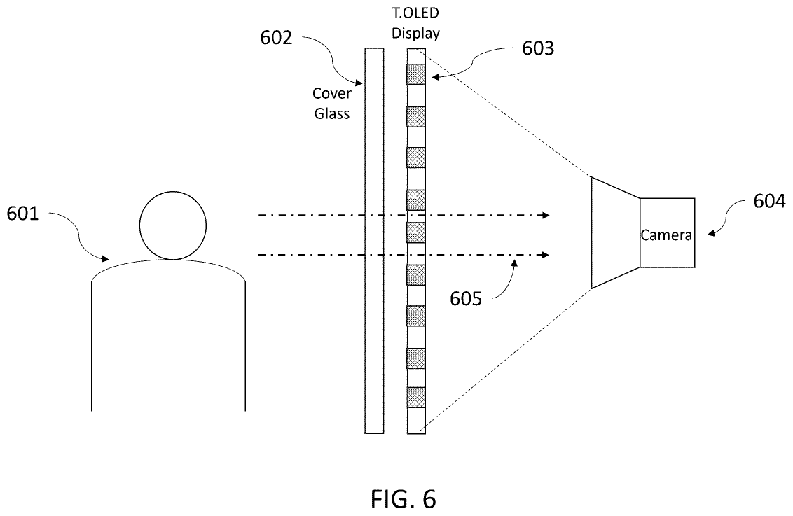

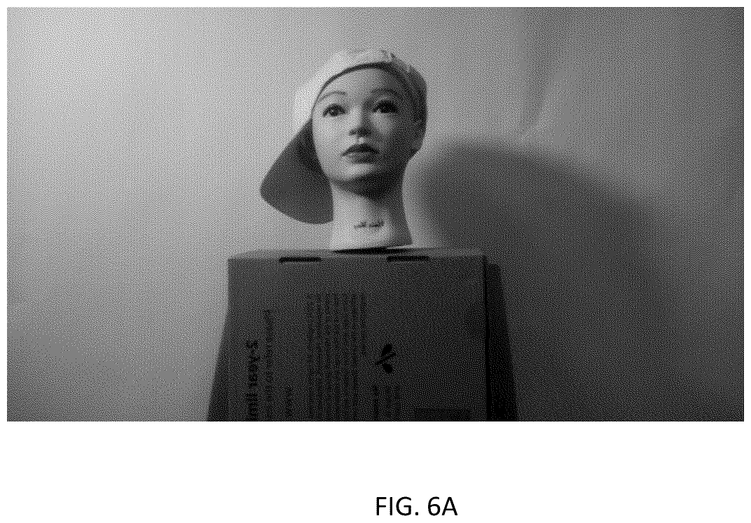

In contrast, FIG. 6 illustrates when T.OLED pixels 603 are not emitting light to the front of the display, the cover glass 602 does not reflect light backward, and therefore, the Moiré pattern interference does not appear in the camera's captured image. Only regular light 605 from the person in front of the display transmits backward to the camera disposed behind the display. FIG. 6A is an image captured by the camera disposed behind the T.OLED display when the display is completely turned off. In this case, none of the T.OLED pixels 603 emitted light to the front, and no light was reflected backward. The picture is free of the interference of the Moiré pattern. However, the T.OLED is not as transparent as a clear sheet of glass, and it is apparent that distortion caused by the pixel mesh is still present. The present invention removes all distortion from the picture so that it is indistinguishable by a human between the invention's corrected image and an image captured through a clear sheet of glass.

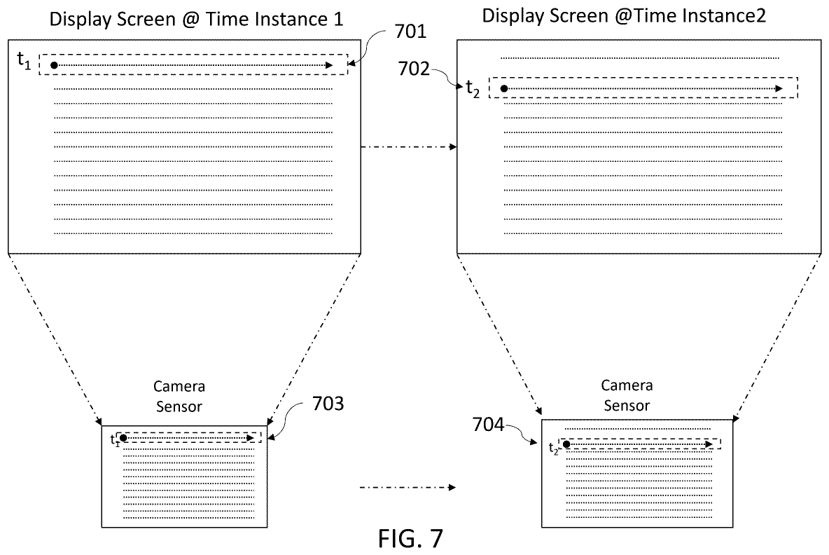

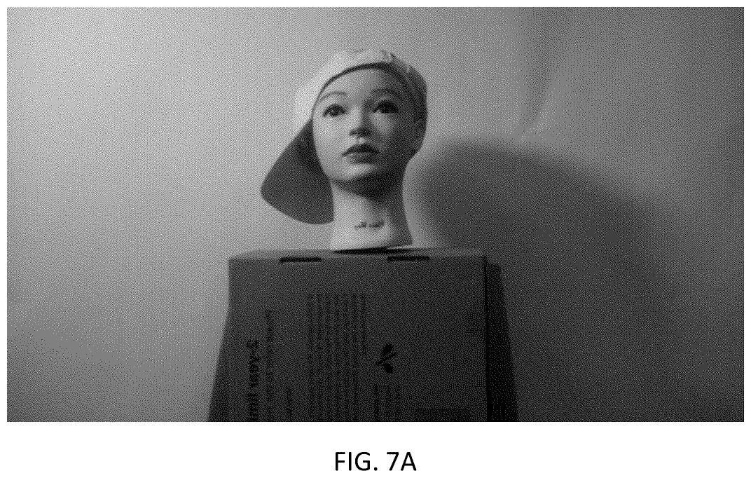

FIG. 7 illustrates a technique to eliminate the Moiré pattern interference according to an embodiment of the invention. Here, the black pixel line refresh is synchronized with the movement of the camera's rolling shutter opening so that the camera sensor only exposes a line of sensor pixels to capture a line of the image of a person in front of the display when the corresponding line of display pixels is turned black. At time instance t₁, display pixel line 701 is refreshed to color black, and in synchronicity, sensor scan line 703 is opened by the rolling shutter control. At this time instance, there is light emitting from the display pixels in line 701, and no light will be reflected backward by the cover glass; the camera sensor captures light 605 transmitting from the front to the back without interference of the Moiré pattern, nor see any reflected ghost image of the digital content on the display.

In this method, the T.OLED display is required to refresh at least at 120 Hz, meaning it can finish refreshing an entire image frame of pixels within 8.33 ms per frame (=1 sec/120 fps), or 11.5 μs per line (=8.33 ms/720). This high refresh rate is necessary to ensure human eyes do not perceive any black pixel lines causing flashing or flickering on the display. The camera sensor must capture and transmit at a speed of 60 frames per second while exposure time (not including data processing, buffering, and transmitting delays) for scanning a full frame of pixel lines must finish within 6 ms to 7 ms. This ensures that when a line of black pixels is present for the duration of 11.5 μs, the sensor's rolling shutter finishes scanning or exposing a sensor pixel line within the same period. For a 1080P resolution display and a matching 1080P resolution camera sensor, it is conceivable the camera sensor must scan faster, finishing sensor scanning per line within 7.7 μs. FIG. 7A is a picture of a manikin model in front of a T.OLED display captured by a camera disposed behind the display on the backside. The black pixel lines of the display were refreshed in synchronization with the rolling shutter opening of sensor pixel scan lines, effectively removing any ghost image or Moiré pattern interference.

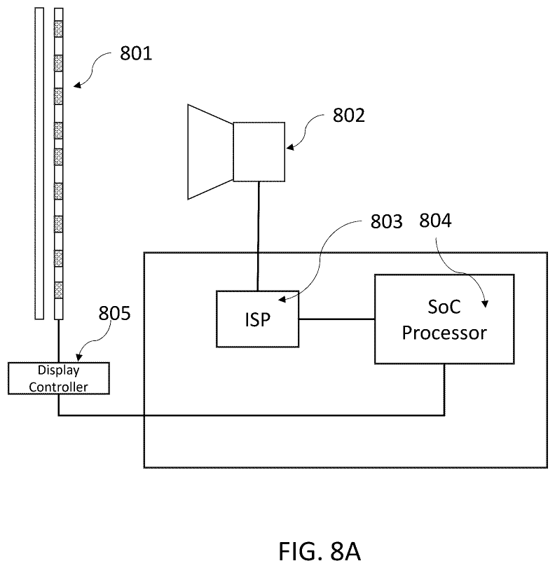

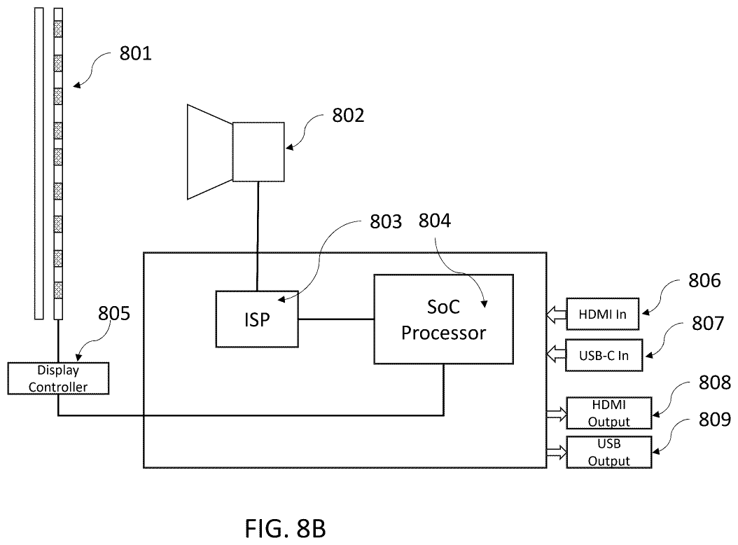

FIG. 8A illustrates a transparent display system according to an embodiment of the invention. The system comprises a camera 802 disposed positioned behind, i.e., rear of, a transparent display 801 along the display's center axis on its back side and a processor 804, which may take the form of a system on a chip (SoC). The center axis is the axis that traverses perpendicularly through the center of the display area. Within the scope of this invention, the camera can also be positioned off the center axis and directed toward the center of the display area in alternative embodiments, preferably with the entire display screen within the camera's field of view. The captured video in such an angular placement can be corrected using optics or digital signal processing. Most displays come with a built-in display controller 805, and most cameras need to work with an image signal processor (ISP) 803, but these components are beyond the scope of the present invention.

FIG. 8B illustrates an alternative embodiment of the transparent display system. In addition to the system shown in FIG. 8A, the system may include any combination of ports such as but not limited to USB3 or USB2 807, an HDMI in port 806, an HDMI out port 808, and a USB OTG output port 809. The addition of input and output connectivity allows for the system to connect with an external content source device or an external host terminal device, enabling the system to be used as a second monitor, a digital teleprompter, a peripheral device like a webcam, or a collaborative communications device with a shared virtual glass board within a video conferencing context.

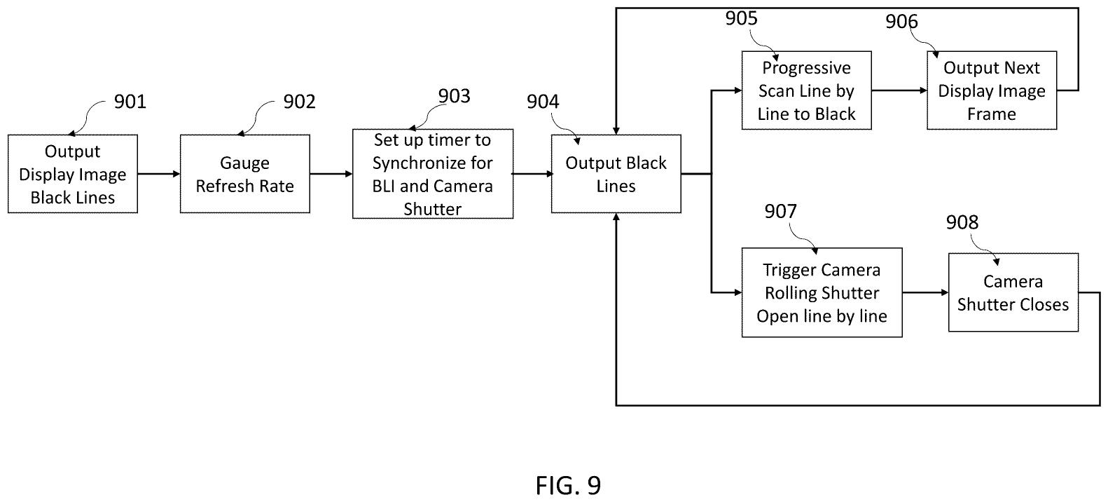

FIG. 9 illustrates a method for black line insertion synchronized with a camera sensor's rolling shutter line-by-line scanning to remove the ghost image and Moiré pattern interference. At step 901, the system's processor outputs a batch of black lines to the display to measure the elapsed time for refreshing a single line of pixels. At step 902, the processor gauges the display's refresh rate by using a photo-sensitive diode sensor or measuring the time to finish a full frame of pixels on the display and/or the beginning and ending times to refresh each pixel line. The timing information is used subsequently to set a timer to synchronize black line insertion (BLI) and camera rolling shutter movement in step 903. The processor outputs BLI in between two display frames in step 904. The display initiates a line-by-line refresh of pixels to black in step 905, and when the refresh is finished for a full screen of pixels, the processor outputs a frame of the display image in step 906. When step 906 is complete, the process loops back to step 904. Simultaneous to step 905, the processor sends a trigger signal in step 907 based on the timer to the camera shutter control interface, such as a GPIO port or I2C port to open the rolling shutter to scan line by line matched in space and time to capture images when the black line by black line is refreshed on the display. When all the pixel lines are refreshed, and the camera shutter has finished scanning all sensor scan lines, the camera shutter closes in step 908, then repeats by waiting for step 904 to start again.

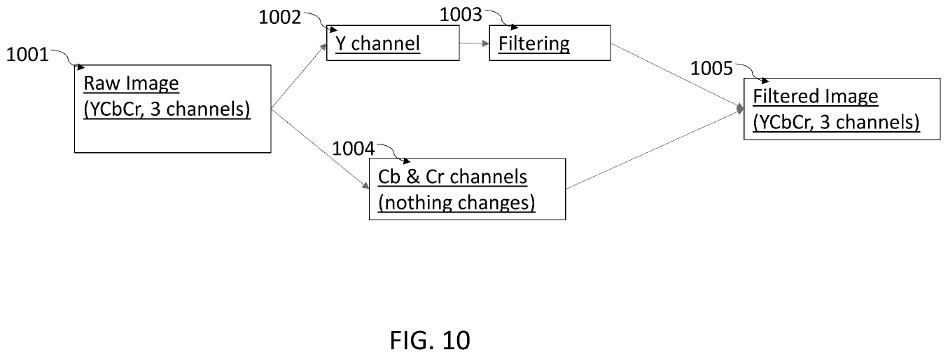

FIG. 10 illustrates a method for raw image encoding, Y channel filtering, and image correction to produce the final filtered image according to an embodiment of the invention. This method eliminates the distortion created by the pixel mesh structure. At step 1001, the raw image data captured by the behind-display camera is encoded into the YCbCr color space. Mesh distortion largely influences the Y channel, which encodes light intensity or brightness information. The Y channel is isolated in step 1002, and spatial filtering is performed on the Y channel in step 1003. The Cb and Cr channels are left unchanged at 1004. After filtering the Y channel, the filtered Y channel data is recombined with the Cb and Cr channels to create a filtered image at 1005. By filtering only the Y channel, without performing any filtering on the other two channels, Cb and Cr, the present invention effectively eliminates the distortion caused by the mesh pattern with a savings factor of three in computation.

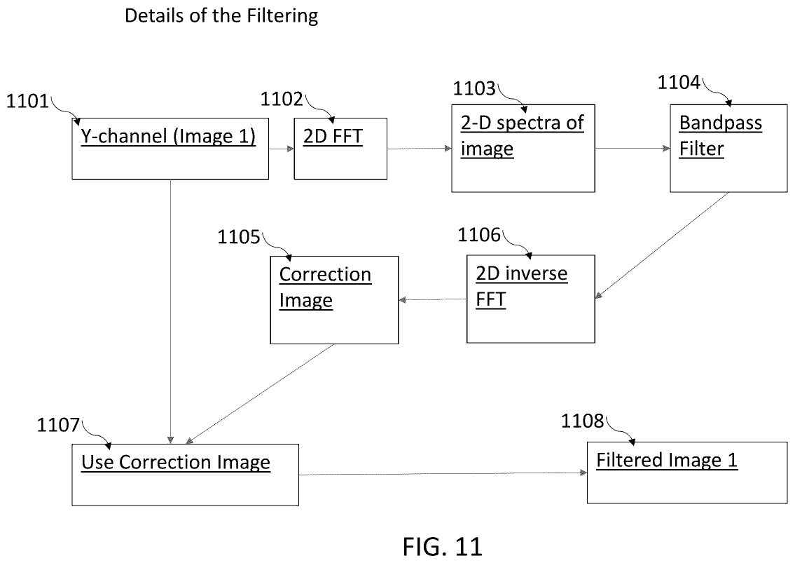

FIG. 11 illustrates a method for creating the Y channel filter, expanding the inner workings of step 1003 above. A two-dimensional fast Fourier transformation (2D FFT) is performed at step 1102 against the Y channel image data 1101. As a result, the FFT transformation produces 2-D spectra of the Y channel image at step 1103. The signature profile frequency distribution pattern in the 2-D spectra is identified in step 1103. Subsequently, a bandpass filter isolating the frequency distribution profile is created in step 1104. After eliminating every other frequency outside of the bandpass filter, the filtered spectra undergo a 2D inverse FFT in 1106, which transforms the frequency profile back to the spatial domain of the Y channel. The resulting spatial domain image from the 2D inverse FFT of step 1106 is the correction image 1105, capturing the spatial domain profile of the mesh structure. Using the correction image of 1105 as the offset against the Y channel raw image at step 1107 results in the filtered image of step 1108, eliminating the distortion of the mesh.

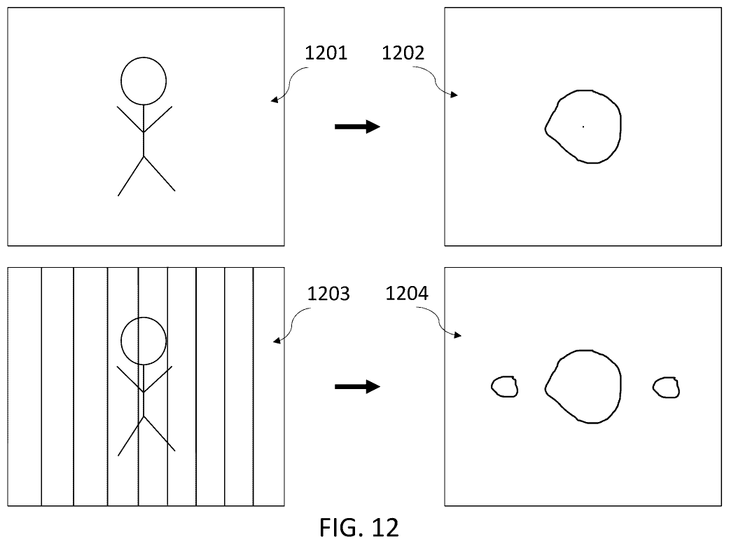

FIG. 12 illustrates when a person is in front of a clear sheet of glass in 1201, the captured image transformed with a 2D FFT results in a spectra profile in the frequency domain, specifically near the center (0,0) point of the spectra, similar to the picture 1202. When a person is in front of a display with a vertical pattern mesh structure, the resulting 2D FFT transformation of image 1203 appears similar to picture 1204, showing two distinct notches representing the mesh distortion in its frequency distribution profile.

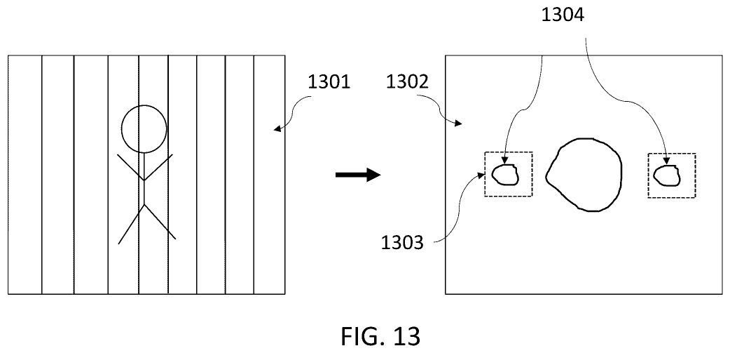

FIG. 13 illustrates a person in front of a display 1301. When a 2D FFT is performed against that spatial image, a spectra image 1302 is created in the frequency domain. The bandpass filter noted above is defined by the dashed line boundary boxes 1303. Boxes 1303 are determined by the area occupied by the two side lobes 1304, representing the encoding of the mesh distortion profile in the 2D spectra.

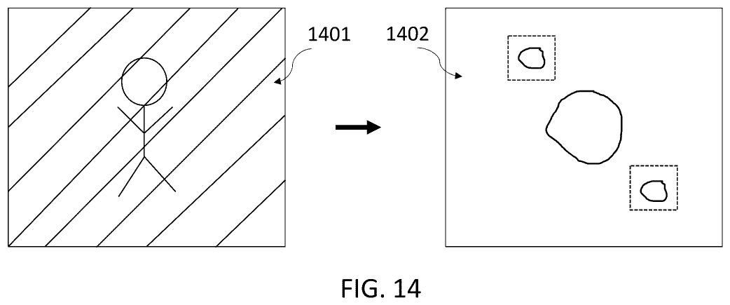

FIG. 14 illustrates when a mesh is oriented diagonally, i.e., at 450 from horizontal, in display 1401. The spectra image in the frequency domain after a 2D FFT transformation is picture 1402. Thus, the region of the mesh spectra profile rotates in direct correlation to the spatial image rotation of the mesh. This discovery helps address different spatial domain distortion patterns based on different mesh designs in a display screen.

In an alternative embodiment of the invention, the 2D FFT transformation is substituted with a direct cosine transformation (DCT) or other transformation capable of achieving 2-D spectra in the frequency domain.

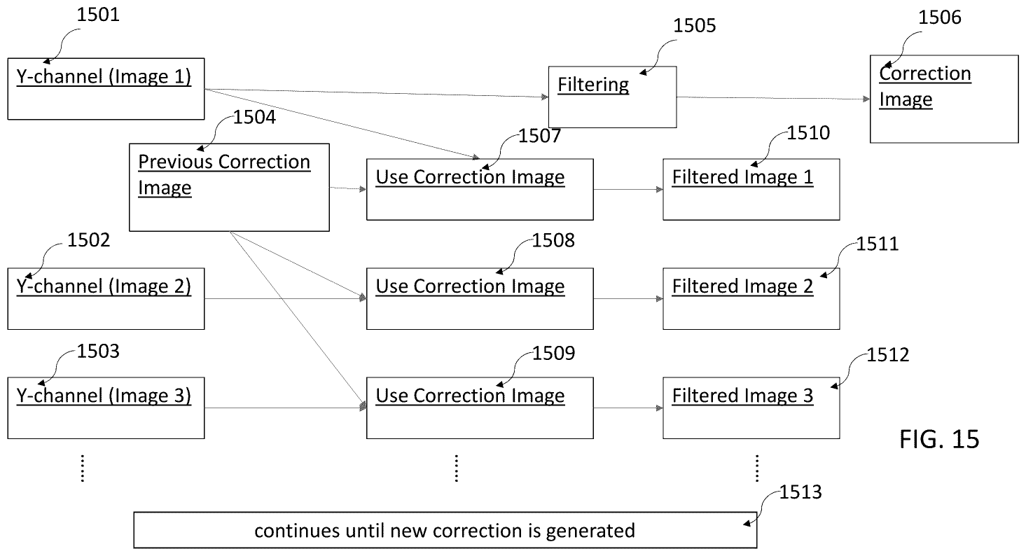

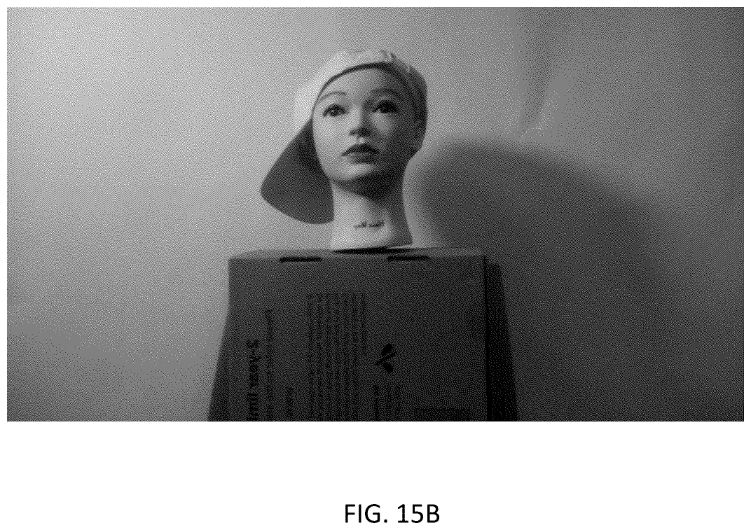

FIG. 15 illustrates applying and reusing a single correction image to a series of captured raw images to avoid overly heavy computation for every frame and ensure a high frame rate display of camera preview images. After filtering 1505 the Y-channel raw image 1501, following the process described above, a correction image 1506 is created. Once this correction image is obtained, it replaces any previously used correction image 1504. The correction image is used as an offset against Y-channel image 1 of 1501 and achieves a filtered image 1 of 1510. Subsequently, instead of filtering and calculating a new correction image for every new frame of a captured image, the inventors discovered that the correction image could be reused due to the fixed nature of the mesh structure and pattern. For a new Y-channel image 2 of 1502, the method applies the same correction image of 1506 as offset at 1508 and achieves filtered image 2 at 1511. Reuse of the correction image of 1506 continues for Y-channel image 3 of 1503 to achieve filtered image 3 of 1512, and so on until a new correction image is generated at 1513. Reusing a single correction image for a series of image frames reduces computational resources by a dozen times and ensures a high frame rate display of filtered images.

FIG. 15B is a picture of a filtered image free of Moiré Pattern interference and mesh distortion. It reaches a clarity level nearly indistinguishable from a picture captured behind a clear sheet of glass, particularly human perception in everyday video conferencing contexts, where image resolution or fine detail is not the primary concern.

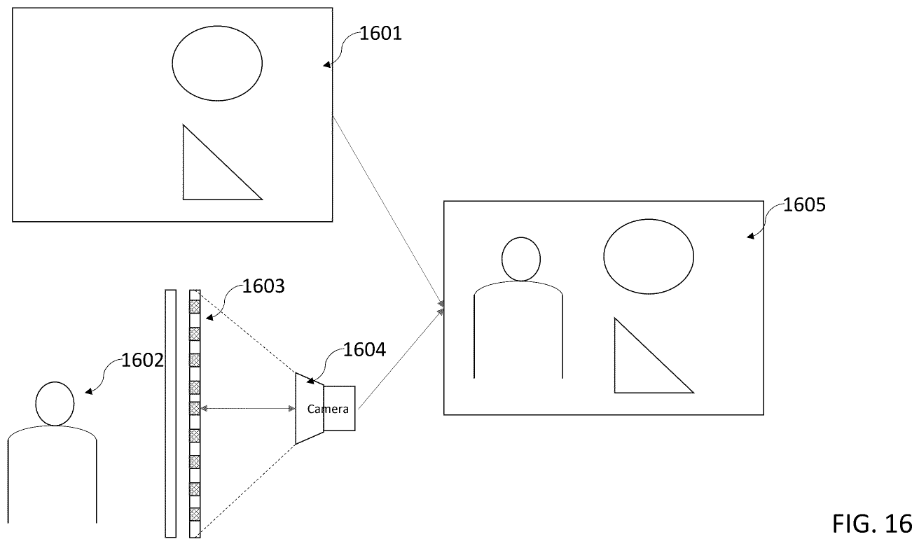

FIG. 16 illustrates a method for constructing a person-embedded view image by combining the camera view of a person in front of the display with digital content shown on the display. In most video applications, digital content 1601 on a computer display is separate from the user's camera view. This is especially the case in video conferencing application windows. Once a screen share is displayed in a video call, the person's view captured by a camera is reduced to a thumbnail view and positioned at a corner of the screen. At the same time, the digital content takes up the majority of the display screen area. In such a prior art environment, the camera view image makes the person appear as if they are looking away instead of at the audience, while in reality, the person is actually looking at the digital content to present the digital content to the audience. The present invention system captures a person image 1602 from behind a display 1603 with a centered behind the display camera 1604 where the person's image appears naturally. The camera then flips the left-right orientation of the person's image to create a mirrored image of the person. The digital content can be made transparent by setting the background color to have a 100% transparent alpha channel, leaving the foreground objects with contrasting and bright colors. The transparent digital content is layered as a superimposing layer on top of the left-right flipped camera view image to achieve a combined image with the person and the digital content embedded together. In this person-embedded view image, the camera correctly captures the person's gaze, pointing, writing, gestures, and expressions. When superimposed with the digital content, the audience sees exactly where the person is gazing, where he is pointing, where and what the person is writing. In the setting of a Zoom or Teams video conference call, the presenter can show the combined view, embedding the person view with the digital content view as a regular camera stream instead of a screen share. This results in a much more natural-looking video, as if the camera is behind a clear sheet of virtual glass, capturing the person's image and the ink the person is writing on the glass.

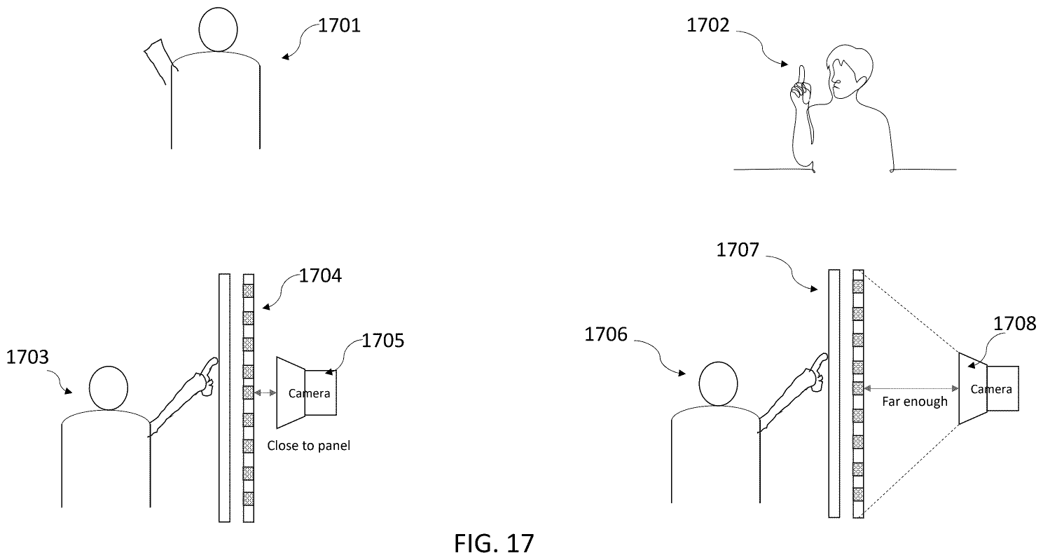

FIG. 17 illustrates the effect of varying the depth of the centered behind the display camera from the back side of the display. As shown on the left side of this figure, camera 1705 is located a short distance from the backside of the display 1704, such as 5-6 centimeters. It will capture most of the person 1703 in front of the display before the person starts to touch the surface to write on it. However, once the person begins writing by touching the display surface, if it's interactive, the person's hand or fingertip may go beyond the FOV of the camera and appear as if the hand is clipped off. At a different distance like that shown on the right, using camera 1708, when the camera is far enough to include the entire backside of the display inside of its FOV, the person's finger, hand, and whole arm are all visible in a person embedded image of both the person and the digital content. In situations such as diagramming out a concept or a design, it could be highly desirable to see the fingertip of the presenter along with a centered view of the presenter, who appears natural in the image. In other situations, simply capturing the realistic view of a person in a video call by having the camera centered behind the display will suffice.

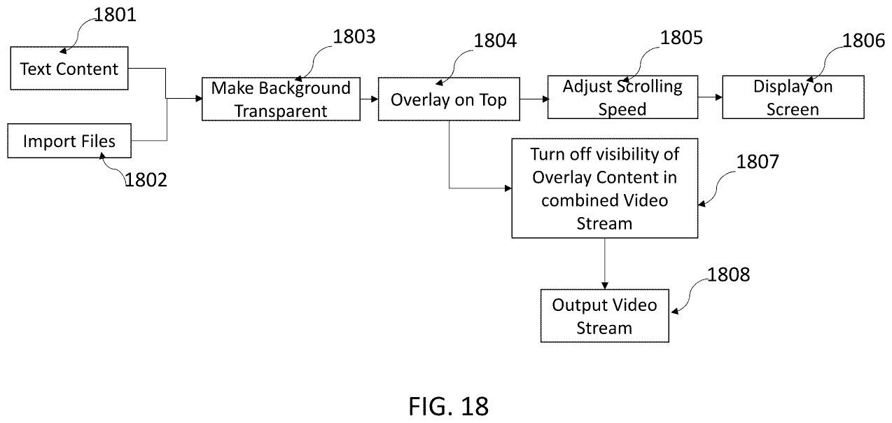

FIG. 18 illustrates a method for applying the system of the present invention as a digital teleprompter. When a script content is acquired in steps 1801 or 1802, the content is made background transparent at step 1803. The digital script content is then placed as an overlay layer on top of a person-embedded image with both the person in front of the display and other digital content presented on the display at step 1804. The script content can automatically scroll to match the person's audio narrative speed at step 1805. The script content is visible at step 1806 for use as a confidence monitor. For any video recording or for presenting in a video conference call setting, the overlay content is set to be invisible to the recorded or transmitted video stream at 1807 and 1808.

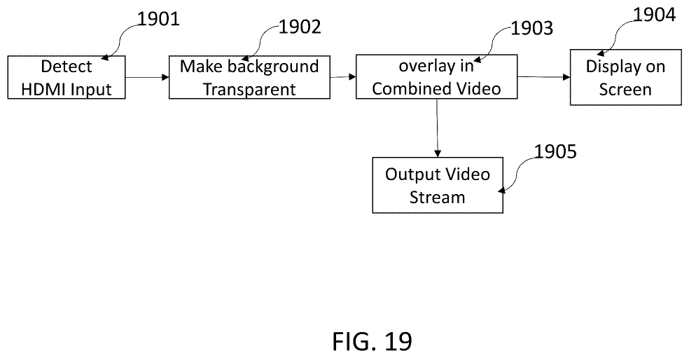

FIG. 19 illustrates a method where the system of the present invention is used as a second monitor for an external computer. The processor of the present invention detects external input sources through an HDMI input port at step 1901. Due to the nature of the HDMI connection industry standard, the external computer would automatically recognize the system of the present invention as a connected monitor. The external computer will then output an HDMI video stream. The system of the present invention accepts the HDMI video stream input and makes the video stream background transparent, leaving the foreground in high contrast and bright colors at step 1902. The input HDMI video stream is then combined with or overlaid at step 1903 on top of local digital content on the system's display combined with the person-embedded view image already combining a person's camera view with local digital content.

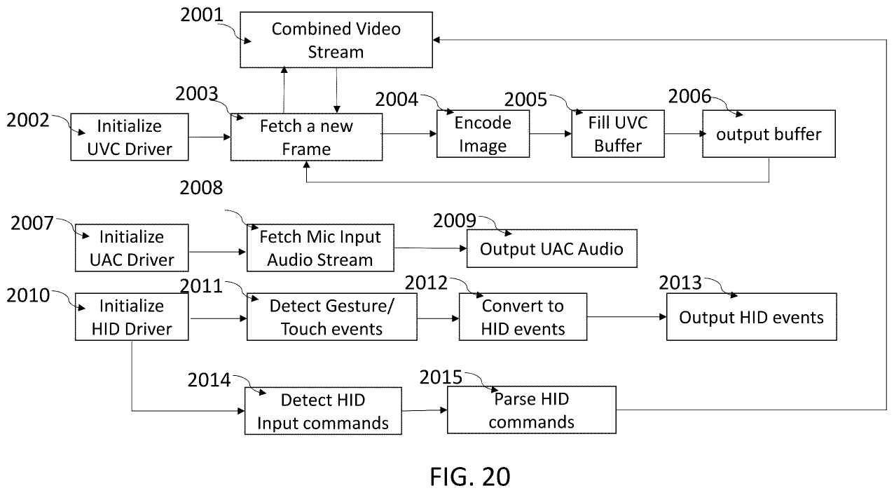

FIG. 20 illustrates a method where the system of the present invention functions as a simple webcam for an external computer. An external computer can bring in the entire person-embedded view image of the system as a webcam and let the webcam UVC stream appear in a video conference call as if the system is a simple webcam. The natural appearance of the user and the combined digital content improves the video conference significantly. To accomplish this, the system's processor initializes a UVC driver 2002, a UAC driver 2007, and a HID driver 2010. The processor fetches a new image from the person-embedded image stream 2001 just constructed through previous methods described above, at 2003. The method encodes the fetched image using a CODEC at 2004, fills a UVC buffer at 2005, and outputs with encoded UVC data format through an output buffer in 2006 via a USB OTG port such as 809 of FIG. 8B. For audio stream output, the processor fetches a microphone input audio stream at step 2008, then encodes the audio using an audio CODEC, and outputs UAC formatted audio stream via a USB OTG port such as 809. For HID event data, the processor detects events from gesture recognized, touch events, keyboard, trackpad, or mouse events in step 2011, then encodes into USB HID event data format at step 2013, and outputs through a USB OTG output port like 809.

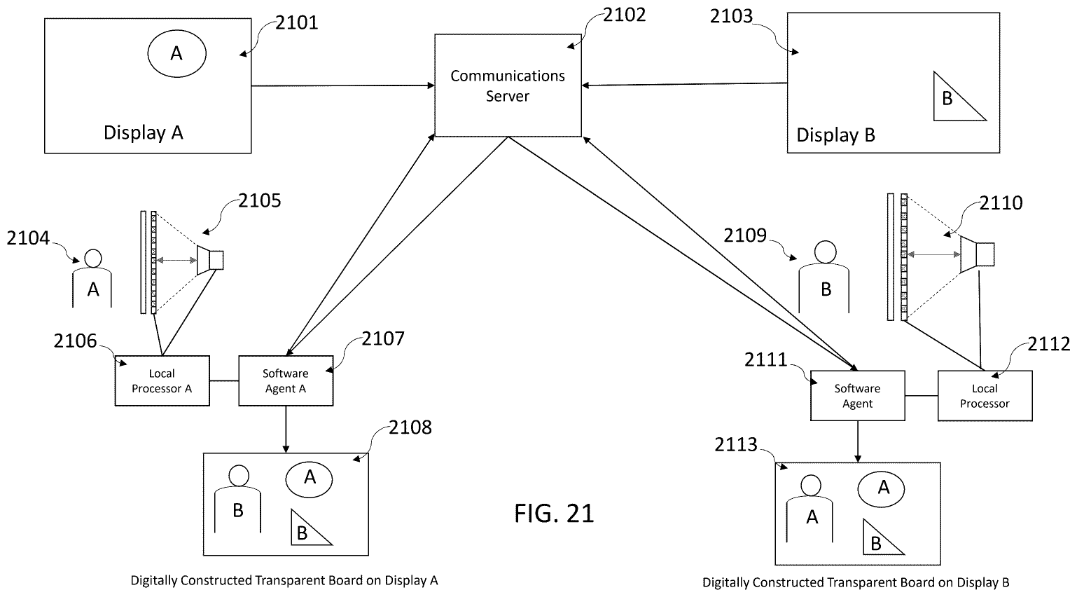

FIG. 21 illustrates a collaborative video communication system that incorporates a cloud-based communications server to facilitate the system in FIG. 16 to work with the same remote system to combine the person-embedded image view with a shared digital virtual glass board. In such a system, both parties of the video conference communication see the other party's person-embedded view images while sharing a transparent digital “glass” board so that each party can write or add digital content to the commonly shared board. Each party can see in the person-embedded view exactly where the other party is pointing or where or what the other party is writing.

Using the system of FIG. 16, system A, a circle is displayed on display A of system A to form a digital content view A at 2101. Also, in system A, person A is in front of display A, with a behind display center camera at 2105 producing a person A embedded digital view A. Furthermore, a local processor A controls the processes in system A, working with a software agent A at 2107. In a remote second system, using the same system of FIG. 16, system B, a triangle is displayed on display B of system B to form a digital content view B 2103. Also, in system B, person B 2109 is in front of display B 2110, with a camera behind the display to produce person B embedded digital view B. Furthermore, a local processor B 2112 controls the processes in system B, working with a software agent B, at 2111. The effect of this communications system is that person A 2104 will view the digital view A+B with person B embedded as in 2108, while person B 2109's view is a constructed digital view A+B with person A embedded as in 2113.

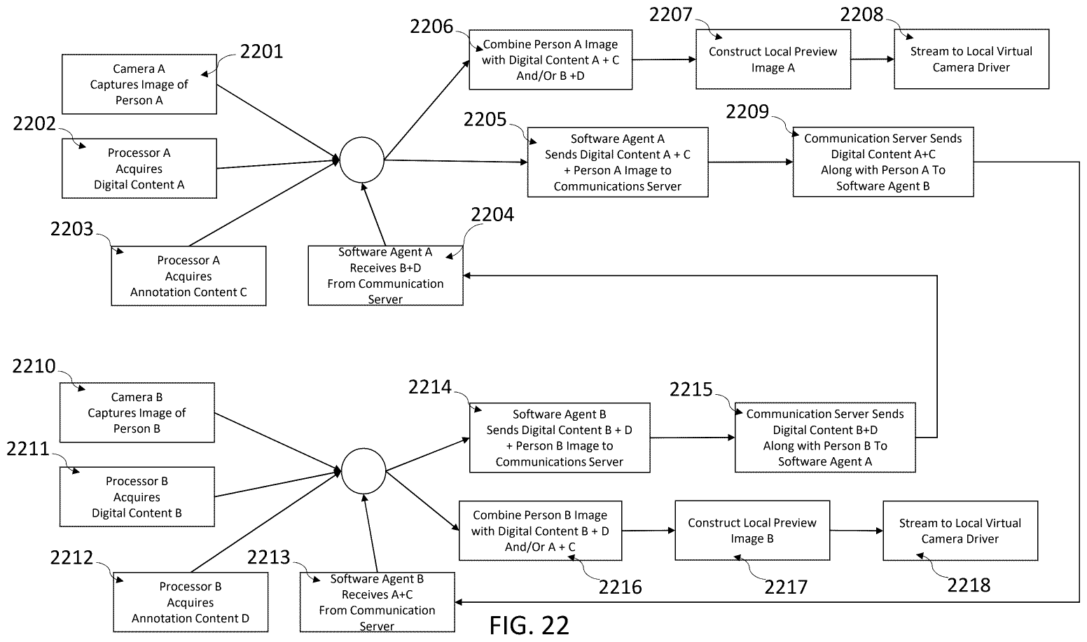

FIG. 22 illustrates the method for the system in FIG. 21, enabling two parties, person A and person B, to collaborate via a communications server with person-embedded view images of each other in a constructed digital image sharing a digital virtual glass board with each other's person view embedded. In system A, camera A captures person A image at 2201. Processor A acquires digital content A image at 2202, accepts new annotation C at 2203, and receives through software agent A from the communications server of digital content B+D at 2204. Processor A combines person A image with digital content A+C+B+D image into a person A embedded digital view A at 2206. Processor A stream constructs person A embedded digital view A to local virtual camera preview driver at 2208. Processor A sends person A image, digital content A+C+B+D, and person A embedded digital view A to the communications server at 2209. The communications server sends those three distinctive image streams to software agent B at 2213. System B performs the reciprocal actions of system A, and processor B sends its respective three image streams to the communications server, which sends the system B side streams to software agent A at 2204. Both sides see the same virtual glass board with all digital content A+B+C+D. Person A will see a person B embedded digital image with A+B+C+D and person B will see a person A embedded digital image with content A+B+C+D.

The invention has been described herein using specific embodiments for illustration only. However, it will be readily apparent to one of ordinary skill in the art that the invention's principles can be embodied in other ways. Therefore, the invention should not be regarded as limited in scope to the specific embodiments disclosed herein; it should be fully commensurate in scope with the following claims.

We claim:

1. A system for video conferencing and collaborative communication comprising:
a display screen capable of displaying digital images or video; and
a camera positioned behind and along a center axis of the display screen, wherein the camera comprises a processor and a rolling shutter, the processor controlling movement of the rolling shutter synchronized with a progressive scan signal of the display screen.

2. The system of claim 1, wherein the display screen comprises an active matrix of transparent organic light emitting diodes.

3. The system of claim 1, wherein the display screen comprises a micro-LED display.

4. The system of claim 1, wherein the display screen has a transparency of at least 15%.

5. The system of claim 2, wherein the rolling shutter is positioned so that its field of view captures the active matrix of transparent organic light emitting diodes.

6. The system of claim 1, wherein the rolling shutter is configured to permit the camera to capture images at a rate of at least 60 frames per second.

7. The system of claim 6, wherein the display screen is configured to display images at a refresh rate of 120 hz.

8. The system of claim 1, wherein the progressive scan signal inserts a black line, corresponding to a row of pixels in the display screen, synchronized with a corresponding position of the rolling shutter.

9. The system of claim 8, wherein the processor is configured to apply a filter, in a frequency domain, to a Y-channel of an image captured by the camera during insertion of the black line.

10. A system for video conferencing and collaborative communication comprising:
a transparent display screen capable of displaying digital images or video;
a camera centered behind the display capable of capturing subjects in front of the transparent display screen, wherein the camera comprises an electronic rolling shutter; and
a processor connected to the camera via a control port to control the electronic shutter to open or close in a progressive scan manner.

11. The system of claim 10, wherein the processor is connected to an external digital content source through a USB port, an HDMI port, or a DisplayPort.

12. The system of claim 10, wherein the processor is connected to an external terminal device through an OTG USB port and outputs a video stream.

13. The system of claim 12, wherein the processor further outputs Human Interface Device (HID) event data.

14. A method of capturing video through a transparent display screen, the method comprising the steps of:
displaying, on a transparent display screen, a black-colored batch of pixel lines with a batch size of a single frame,
controlling opening of a camera's rolling shutter in synchronicity with the displaying of the black-colored batch of pixel lines, wherein the rolling shutter opens, in an iterative manner, a single scan line to capture a single pixel line of the transparent display screen, and
controlling closing of the rolling shutter during display of a regular frame of digital content on the transparent display screen.

15. The method of claim 14 further comprising detecting a beginning of a display line of pixels refresh using a photodiode sensor.

16. The method of claim 14 further comprising estimating a refresh line elapse time by measuring a total time between an ending and beginning of two regular frames of digital content divided by a predetermined number of refresh lines.

17. A method of capturing video through a transparent display screen, the method comprising the steps of:
encoding a first raw image captured by a camera positioned behind a transparent display screen into YCbCr image format to create a Y channel, Cb channel, and Cr channel of the first raw image,
filtering the Y channel of the first raw image with a correction image to create a filtered Y channel, and
combining the filtered Y channel with the Cb channel and the Cr channel to create a corrected first image.

18. The method of claim 17, wherein filtering the Y channel of the raw image with a correction image, comprises the steps of:
performing a two-dimensional fast Fourier transform (2-D FFT) to create a 2-D spectra of Y channel image,
applying a bandpass filter on the 2-D spectra of the Y-channel image to create a filtered 2-D spectra of Y channel image, and
performing a 2D inverse FFT on the filtered 2-D spectral of Y channel image.

19. The method of claim 17, further comprising the steps of:
encoding a second raw image captured by a camera positioned behind a transparent display screen into YCbCr image format to create a Y channel, Cb channel, and Cr channel of the second raw image,
filtering the Y channel of the second raw image with the correction image to create a filtered Y channel, and
combining the filtered Y channel with the Cb channel and Cr channel to create a corrected second image.
